(19) United States
(12) Patent Application Publication
(10) Pub. No.: US 2025/0362632 A1
(43) Pub. Date: Nov. 27, 2025

(54) SHEET CONVEYANCE DEVICE, IMAGE FORMING APPARATUS, AND IMAGE READING APPARATUS

(71) Applicant: KYOCERA Document Solutions Inc., Osaka (JP)

(72) Inventor: Hirofumi TSUJI, Osaka (JP)

(73) Assignee: KYOCERA Document Solutions Inc., Osaka (JP)

(21) Appl. No.: 19/205,388

(22) Filed: May 12, 2025

(30) Foreign Application Priority Data
May 27, 2024 (JP) 2024-085387

(51) Int. Cl. G03G 15/00; G03G 15/20; G03G 21/16

(52) U.S. Cl. CPC G03G 15/6511; G03G 15/2014; G03G 21/1695; G03G 2215/00189; G03G 2215/004; G03G 2215/00708

(57) ABSTRACT

A sheet conveyance device includes a rotating member that rotates while in contact with a sheet to convey the sheet, and a cleaning portion that cleans the rotating member. The cleaning portion has a cleaning member that makes contact with the outer circumferential surface of the rotating member to remove foreign substances from the outer circumferential surface of the rotating member and a housing that stores the foreign substances removed from the outer circumferential surface of the rotating member. A part of the housing is arranged at a position where it can make contact with the sheet, and guides the sheet conveyed by the rotating member.

### INCORPORATION BY REFERENCE

This application is based on and claims the benefit of priority from Japanese Patent Application No. 2024-085387 filed on May 27, 2024, the contents of which are hereby incorporated by reference.

### BACKGROUND

The present disclosure relates to a sheet conveyance device, an image forming apparatus, and an image reading apparatus.

A conventional sheet conveyance device includes a rotating member that rotates while in contact with a sheet to convey the sheet. Conventionally, a roller is used as the rotating member to convey the sheet.

### SUMMARY

According to a first aspect of the present disclosure, a sheet conveyance device includes a rotating member and a cleaning portion. The rotating member rotates while in contact with a sheet to convey the sheet. The cleaning portion cleans the rotating member. The cleaning portion has a cleaning member and a housing. The cleaning member makes contact with the outer circumferential surface of the rotating member to remove foreign substances from the outer circumferential surface of the rotating member. The housing stores the foreign substances removed from the outer circumferential surface of the rotating member. A part of the housing is arranged at a position where it can make contact with the sheet, and guides the sheet conveyed by the rotating member.

According to a second aspect of the present disclosure, an image forming apparatus includes the sheet conveyance device described above and a print portion. The print portion prints on the sheet being conveyed by the sheet conveyance device.

According to a third aspect of the present disclosure, an image reading apparatus includes the sheet conveyance device described above and an image reading portion. The image reading portion reads an image formed on the sheet being conveyed by the sheet conveyance device.

### BRIEF DESCRIPTION OF THE DRAWINGS

FIG. 1 is an outline diagram showing the internal construction of a multifunction peripheral according to an embodiment.

FIG. 2 is a schematic diagram of a paper feeding device according to the embodiment.

FIG. 3 is a schematic diagram showing the internal construction of a document feeding device according to an embodiment.

FIG. 4 is a schematic diagram of and around a document feeding belt cleaning portion provided in the document feeding device according to the embodiment.

### DETAILED DESCRIPTION

An embodiment of the present disclosure will be described below, taking a multifunction peripheral as an example.

### <Overall Configuration of a Multifunction Peripheral>

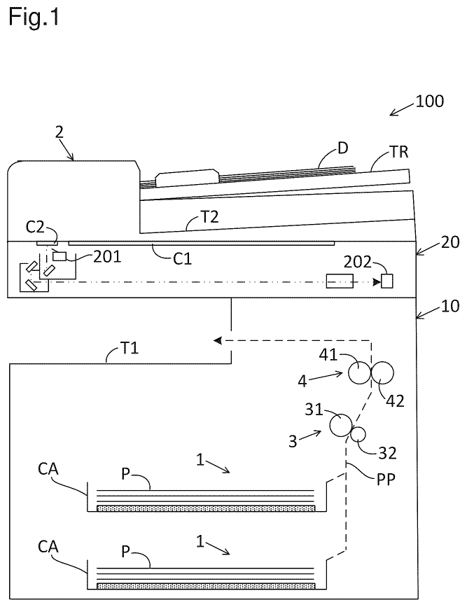

The multifunction peripheral 100 according to the embodiment has the configuration shown in FIG. 1. The multifunction peripheral 100 corresponds to an “image forming apparatus” and an “image reading apparatus”. The multifunction peripheral 100 includes a paper feeding device 1 and a document conveyance device 2 as sheet conveyance devices. The paper feeding device 1 conveys paper P as a sheet. The document conveyance device 2 conveys a document D as a sheet. The configurations of the paper feeding device 1 and the document conveyance device 2 will be described in detail later.

In the following description, the direction orthogonal to the conveyance direction of the sheet (the paper P and the document D) in the multifunction peripheral 100 is referred to as the width direction. The direction perpendicular to the plane of FIG. 1 is the width direction. For example, the front-rear direction of the multifunction peripheral 100 corresponds to the width direction.

The multifunction peripheral 100 includes a print portion 10. The print portion 10 includes a paper conveyance passage PP (in FIG. 1, the paper conveyance passage PP is indicated by a broken line). The print portion 10 feeds the paper P to the paper conveyance passage PP and conveys the paper P along the paper conveyance passage PP. The paper feeding device 1 feeds the paper P to the paper conveyance passage PP. The print portion 10 performs a print job. That is, the print portion 10 prints an image on the paper P being conveyed along the paper conveyance passage PP.

The print portion 10 includes one or more pairs of paper conveyance rollers, which are not shown. The pair of paper conveyance rollers have a pair of rollers kept in pressed contact with each other. The pair of paper conveyance rollers have a region between the pair of rollers as a paper conveyance nip. The pair of paper conveyance rollers rotate to convey the paper P having entered the paper conveyance nip. In other words, the pair of paper conveyance rollers nip the paper P between the pair of rollers and rotates in that state to convey the paper P. The pairs of paper conveyance rollers are arranged in the paper conveyance passage PP and convey the paper P along the paper conveyance passage PP.

The print portion 10 includes an image forming portion 3. The image forming portion 3 includes a photosensitive drum 31 and a transfer roller 32. The photosensitive drum 31 carries a toner image on its circumferential surface. The transfer roller 32 is in pressed contact with the photosensitive drum 31 and forms a transfer nip with the photosensitive drum 31. The transfer roller 32 rotates together with the photosensitive drum 31. The image forming portion 3 conveys the paper P having entered the transfer nip while transferring the toner image to the paper P. Thus, an image is printed on the paper P.

The image forming portion 3 includes a charging device, an exposure device, and a development device, which are not shown. The charging device electrostatically charges the circumferential surface of the photosensitive drum 31. The exposure device forms an electrostatic latent image on the circumferential surface of the photosensitive drum 31. The development device develops the electrostatic latent image on the circumferential surface of the photosensitive drum 31 into a toner image.

The print portion 10 includes a fixing portion 4. The fixing portion 4 includes a heating roller 41 and a pressing roller 42. The heating roller 41 incorporates a heater. The pressing roller 42 is kept in pressed contact with the heating roller 41 and forms a fixing nip with the heating roller 41. The pressing roller 42 rotates together with the heating roller 41. The fixing portion 4 conveys the paper P having entered the fixing nip while fixing to the paper P the toner image transferred to the paper P. The paper P having passed through the transfer nip is discharged to the discharge tray T1.

The multifunction peripheral 100 includes an image reading portion 20. The image reading portion 20 reads an image formed on the document D and generates the image data of the read document D. In a copy job which is a print job that involves the reading of a document D, the print portion 10 prints on the paper P an image based on the image data of the document D resulting from reading the document D. In a scan job, the image data of a document D resulting from reading the document D is transmitted to and stored in the external device. The external device can be, for example, a personal computer communicably connected to the multifunction peripheral 100 and an external memory (for example, a USB memory) attached to the multifunction peripheral 100.

The image reading portion 20 includes a contact glass C1 on which the document D is placed. On the contact glass C1, the user places the document D. The image reading portion 20 includes a contact glass C2. Onto the contact glass C2, the document conveyance device 2 automatically conveys the document D.

The image reading portion 20 includes optical members such as a light source 201, an image sensor 202, and a mirror (no reference sign assigned). The light source 201 irradiates the document D with light. The reflected light from the document D is reflected by the mirror and is guided to the image sensor 202. The image sensor 202 receives the reflected light from the document D. The image reading portion 20 subjects the output value of the image sensor 202 having received the reflected light from the document D to A/D conversion and thereby generates the image data of the document D to be used in a copy job, a scan job, or the like.

The image reading portion 20 reads the document D in one of two reading modes: a stationary reading mode and a feed-reading mode. In the stationary reading mode, the user places the document D on the contact glass C1, then light is shone onto the document D on the contact glass C1, and based on the reflected light, the image data of the document D is generated. On the other hand, in the feed-reading mode, the document conveyance device 2 conveys the document D onto the contact glass C2, then light is shone onto the document D conveyed across the contact glass C2, and based on the reflected light, the image data of the document D is generated.

FIG. 1 schematically shows the path of the light emitted from the light source 201 and the light reflected by the document D with a dash-dot-dot line. FIG. 1 shows, as one example, the path of the light reflected by the document D on the contact glass C2.

### <Configuration of the Paper Feeding Device>

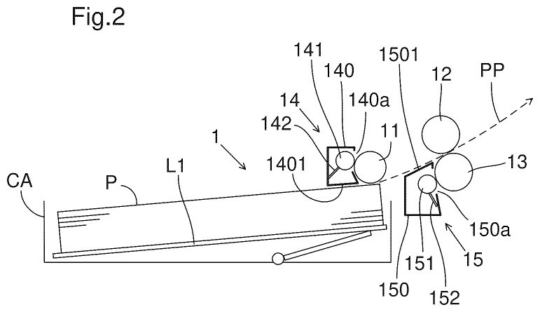

The paper feeding device 1 has a configuration as shown in FIG. 2. The paper feeding device 1 has part of the paper conveyance passage PP. The paper conveyance passage PP in the paper feeding device 1 leads to the paper conveyance passage PP in the main body of the multifunction peripheral 100. The paper feeding device 1 feeds the paper P to the paper conveyance passage PP and conveys the paper P along the paper conveyance passage PP. Thus, the paper P is fed to the main body (that is, the print portion 10) of the multifunction peripheral 100.

The paper feeding device 1 includes a paper cassette CA. The paper cassette CA is removably mountable in the main body of the multifunction peripheral 100. The paper P is set in the paper cassette CA. As the print job is performed, the paper P in the paper cassette CA is consumed and decreases. As the print job is performed and the paper P in the paper cassette CA runs out, the paper cassette CA is removed out of the main body of the multifunction peripheral 100 and paper P is set in the paper cassette CA. After the paper P is set in the paper cassette CA, the paper cassette CA is mounted back in the main body of the multifunction peripheral 100.

In the paper cassette CA is arranged a paper lifting plate L1. Setting the paper P in the paper cassette CA leaves the paper P placed on the paper lifting plate L1. The paper lifting plate L1 can be displaced such that its downstream end in the paper conveyance direction swings in the up-down direction about its upstream end in the paper conveyance direction. In other words, the paper lifting plate L1 is movable up and down. In the following description, the rising of the paper lifting plate L1 means the upward movement of the downstream end of the paper lifting plate L1 in the paper conveyance direction.

The paper feeding device 1 includes a paper pickup roller 11. The paper pickup roller 11 is supported so as to be rotatable about an axis extending in the width direction. The paper pickup roller 11 is coupled to a motor, which is not shown, and rotates by being fed with a driving force from the motor. The paper pickup roller 11 is arranged opposite the paper lifting plate L1 in the up-down direction. With the paper P set in the paper cassette CA, the paper P on the paper lifting plate L1 and the paper pickup roller 11 faces each other in the up-down direction. The paper pickup roller 11 rotates while in contact with the top layer of the paper P on the paper lifting plate L1 from above. The paper pickup roller 11, by rotating while in contact with the paper P on the paper lifting plate L1, conveys the paper P on the paper lifting plate L1. Thus, the paper P is pulled out of the paper cassette CA.

During the print job, the paper lifting plate L1 rises and stops rising repeatedly. The paper lifting plate L1 rises until it makes contact with the paper P in the top layer on the paper lifting plate L1 and when the contact pressure with the paper P in the top layer on the paper lifting plate L1 reaches a target value, it stops rising. Thus, even when the paper P in the paper cassette CA decreases, the paper P in the paper cassette CA and the paper pickup roller 11 are kept in contact with each other.

The paper feeding device 1 includes a paper feed roller 12 and a paper separation roller 13. The paper feed roller 12 and the paper separation roller 13 are arranged downstream of the paper pickup roller 11 in the paper conveyance direction. The paper feed roller 12 and the paper separation roller 13 are supported so as to be rotatable about an axis extending in the width direction.

The paper feed roller 12 rotates by being fed with a driving force from a motor, which is not shown (for example, the same one as the motor coupled to the paper pickup roller 11). The paper separation roller 13 is in pressed contact with the paper feed roller 12 and it forms a paper feed nip with the paper feed roller 12. When the paper P is pulled out of the paper lifting plate L1, the paper P enters the paper feed nip. The paper feed roller 12 and the paper separation roller 13, by rotating while in contact with the paper P having entered the paper feed nip, conveys the paper P having entered the paper feed nip.

The paper separation roller 13 is coupled to a torque limiter (not shown). The torque limiter is arranged on the rotation shaft of the paper separation roller 13. The torque limiter keeps the rotation shaft of the paper separation roller 13 unrotatable if a rotational driving force transmitted from the paper feed roller 12 to the paper separation roller 13 is equal to or lower than a threshold value. When one and the subsequent sheets of paper P overlapping with each other enter the paper feed nip, the paper feed roller 12 makes contact with the first sheet P and advances it, but the paper separation roller 13 does not make contact with the first sheet P and makes contact with the second sheet P. This makes it difficult for the rotational driving force to be transmitted from the paper feed roller 12 to the paper separation roller 13. Thus, the rotational driving force transmitted from the paper feed roller 12 to the paper separation roller 13 becomes equal to or lower than the threshold value and the paper separation roller 13 does not rotate.

In this way, while the paper feed roller 12 rotates, the paper separation roller 13 does not; this prevents the advancement of the second sheet P that is out of contact with the paper feed roller 12 but in contact with the paper separation roller 13. Thus, one and the subsequent sheets of paper P are separated. This eliminates double feeding, that is, feeding of a plurality of sheets of paper P overlapping with each other.

### <Configuration of the Paper Pickup Roller Cleaning Portion>

The paper feeding device 1 includes a paper pickup roller cleaning portion 14 (see FIG. 2). The paper pickup roller cleaning portion 14 cleans the paper pickup roller 11. With this configuration, the paper pickup roller cleaning portion 14 corresponds to a “cleaning portion” and the paper pickup roller 11 corresponds to a “rotating member”.

The paper pickup roller cleaning portion 14 removes foreign substances from the outer circumferential surface of the paper pickup roller 11. On the outer circumferential surface of the paper pickup roller 11, paper dust deposits as a result of the paper P making contact with it. In the cleaning of the paper pickup roller 11 by the paper pickup roller cleaning portion 14, at least paper dust is removed as foreign substances from the outer circumferential surface of the paper pickup roller 11.

The paper pickup roller cleaning portion 14 includes a housing 140, a brush roller 141, and a scraper 142. The brush roller 141 corresponds to a “cleaning member”.

The housing 140 has a storage area. Specifically, the housing 140 is in the shape of a box and has a wall surrounding a space that serves as the storage area. A box-shaped member as the housing 140 has an opening 140a through which the internal area (that is, the storage area) of the housing 140 communicates with an external area. The housing 140 stores the foreign substances removed from the paper pickup roller 11 in the storage area.

The housing 140 is removably mountable in the main body of the multifunction peripheral 100 (in other words, the paper feeding device 1). With the housing 140 removed from the main body of the multifunction peripheral 100, the foreign substances stored in the housing 140 can be disposed of. After disposal, the housing 140 is mounted back in the main body of the multifunction peripheral 100.

The brush roller 141 is rotatably attached to the housing 140. The brush roller 141 has a rotation shaft and a plurality of bristles raised from the outer circumferential surface of the rotation shaft. The brush roller 141 keeps the bristles in contact with the outer circumferential surface of the paper pickup roller 11.

The scraper 142 is attached to the housing 140. The scraper 142 lies in contact with the outer circumferential surface of the brush roller 141. The brush roller 141 rotates with its outer circumferential surface in contact with the scraper 142. The scraper 142 makes contact with the outer circumferential surface of the brush roller 141 to electrostatically charge the brush roller 141. The brush roller 141 electrically attracts foreign substances that deposits on the outer circumferential surface of the paper pickup roller 11 to remove the foreign substances from the outer circumferential surface of the paper pickup roller 11. The scraper 142 makes contact with the brush roller 141 to remove the foreign substances from the outer circumferential surface of the brush roller 141. The foreign substances removed from the outer circumferential surface of the brush roller 141 drop to be stored in the storage area in the housing 140.

The brush roller 141 is arranged in the storage area in the housing 140, with part of it exposed outside the storage area through the opening 140a in the housing 140. The brush roller 141 keeps the part of it exposed through the opening 140a in the housing 140 in contact with the paper pickup roller 11.

The scraper 142 is arranged in its entirety in the storage area in the housing 140. One end of the scraper 142 lies contact with the outer circumferential surface of the brush roller 141 and the other end of it is attached to the housing 140. Thus, the foreign substances removed from the outer circumferential surface of the brush roller 141 by the scraper 142 are stored in the storage area in the housing 140.

With the configuration where the brush roller 141 and the scraper 142 are attached to the housing 140, the brush roller 141 and the scraper 142 can be removed from the main body of the multifunction peripheral 100 simply by removing the housing 140 from the main body of the multifunction peripheral 100 (that is, the paper feeding device 1). Conveniently, it is thus possible, on the occasion of disposing of the stored substances (foreign substances) stored in the housing 140, also to maintain the brush roller 141 and the scraper 142 (for example, to check their wear).

The housing 140 has part of its wall as a guide part 1401. The guide part 1401 guides the paper P conveyed by the paper pickup roller 11.

Specifically, the paper pickup roller cleaning portion 14 is arranged upstream of the paper pickup roller 11 in the paper conveyance direction, above the paper lifting plate L1. Thus, part of the wall of the housing 140 faces the paper lifting plate L1 in the up-down direction. In a state where the paper P is placed on the paper lifting plate L1, part of the wall of the housing 140 faces the paper P on the paper lifting plate L1 in the up-down direction. The part of the wall of the housing 140 that faces the paper P on the paper lifting plate L1 in the up-down direction is the guide part 1401.

Thus, when the paper pickup roller 11 conveys the paper P on the paper lifting plate L1, if the paper P on the paper lifting plate L1 warps up, the top face of the paper P makes contact with the guide part 1401. As a result, the paper P on the paper lifting plate L1 is conveyed by the paper pickup roller 11 satisfactorily. In other words, the guide part 1401 (that is, part of the housing 140) guides the paper P on the paper lifting plate L1 that is conveyed by the paper pickup roller 11. In yet other words, the housing 140 has a guide face and keeps the top face of the paper P on the paper lifting plate L1 conveyed by the paper pickup roller 11 in contact with the guide face to guide the paper P on the paper lifting plate L1.

In this embodiment, as described above, part of the housing 140 (specifically, the guide part 1401) is arranged at a position where it can make contact with the paper P. Then, the part of the housing 140 guides the paper P conveyed by the paper pickup roller 11. This eliminates the need to separately provide, near where the housing 140 is arranged, a member for guiding the paper P and this helps suppress an increase in the size of the paper feeding device 1. It is thus possible to suppress an increase in the size of the paper feeding device 1 while appropriately cleaning the paper pickup roller 11.

By appropriately cleaning the paper pickup roller 11, the foreign substances such as paper dust deposited on the paper pickup roller 11 can be satisfactorily removed. As a result, it is possible to prevent inconvenience such as slippage of the paper pickup roller 11 against the paper P. This helps prevent conveyance failure with the paper P.

For example, an area around the paper pickup roller 11 is covered with a cover that can be opened and closed to ease sheet jam removal. Opening the cover exposes the area around the paper pickup roller 11. With this configuration, opening the cover (that is, the cover for sheet jam removal) around the paper pickup roller 11 conveniently permits the mounting and removal of the housing 140.

In this embodiment, the foreign substances deposited on the brush roller 141 are removed by the scraper 142. This prevents insufficient cleaning of the paper pickup roller 11 by the brush roller 141. The foreign substances removed from the brush roller 141 are stored in the housing 140 and this prevents the foreign substances from scattering around the paper pickup roller 11.

### <Configuration of the Paper Separation Roller Cleaning Portion>

The paper feeding device 1 includes a paper separation roller cleaning portion 15 (see FIG. 2). The paper separation roller cleaning portion 15 cleans the paper separation roller 13. With this configuration, the paper separation roller cleaning portion 15 corresponds to a “cleaning portion” and the paper separation roller 13 corresponds to a “rotating member”.

The paper separation roller cleaning portion 15 removes foreign substances from the outer circumferential surface of the paper separation roller 13. On the outer circumferential surface of the paper separation roller 13, paper dust deposits as a result of the paper P making contact with it. In the cleaning of the paper separation roller 13 by the paper separation roller cleaning portion 15, at least paper dust is removed as foreign substances from the outer circumferential surface of the paper separation roller 13.

The paper separation roller cleaning portion 15 includes a housing 150, a brush roller 151, and a scraper 152. The brush roller 151 corresponds to a “cleaning member”.

The housing 150 has a storage area. Specifically, the housing 150 is in the shape of a box and has a wall surrounding a space that serves as the storage area. A box-shaped member as the housing 150 has an opening 150a through which the internal area (that is, the storage area) of the housing 150 communicates with an external area. The housing 150 stores the foreign substances removed from the paper separation roller 13 in the storage area.

The housing 150 is removably mountable in the main body of the multifunction peripheral 100 (in other words, the paper feeding device 1). With the housing 150 removed from the main body of the multifunction peripheral 100, the foreign substances stored in the housing 150 can be disposed of. After disposal, the housing 150 is mounted back in the main body of the multifunction peripheral 100.

The brush roller 151 is rotatably attached to the housing 150. The brush roller 151 has a rotation shaft and a plurality of bristles raised from the outer circumferential surface of the rotation shaft. The brush roller 151 keeps the bristles in contact with the outer circumferential surface of the paper separation roller 13.

The scraper 152 is attached to the housing 150. The scraper 152 lies in contact with the outer circumferential surface of the brush roller 151. The brush roller 151 rotates with its outer circumferential surface in contact with the scraper 152. The scraper 152 makes contact with the outer circumferential surface of the brush roller 151 to electrostatically charge the brush roller 151. The brush roller 151 electrically attracts foreign substances that deposits on the outer circumferential surface of the paper separation roller 13 to remove the foreign substances from the outer circumferential surface of the paper separation roller 13. The scraper 152 makes contact with the brush roller 151 to remove the foreign substances from the outer circumferential surface of the brush roller 151. The foreign substances removed from the outer circumferential surface of the brush roller 151 drop to be stored in the storage area in the housing 150.

The brush roller 151 is arranged in the storage area in the housing 150, with part of it exposed outside the storage area through the opening 150a in the housing 150. The brush roller 151 keeps the part of it exposed through the opening 150a in the housing 150 in contact with the paper separation roller 13.

The scraper 152 is arranged in its entirety in the storage area in the housing 150. One end of the scraper 152 lies contact with the outer circumferential surface of the brush roller 151 and the other end of it is attached to the housing 150. Thus, the foreign substances removed from the outer circumferential surface of the brush roller 151 by the scraper 152 are stored in the storage area in the housing 150.

With the configuration where the brush roller 151 and the scraper 152 are attached to the housing 150, the brush roller 151 and the scraper 152 can be removed from the main body of the multifunction peripheral 100 simply by removing the housing 150 from the main body of the multifunction peripheral 100 (that is, the paper feeding device 1). Conveniently, it is thus possible, on the occasion of disposing of the stored substances (foreign substances) stored in the housing 150, also to maintain the brush roller 151 and the scraper 152 (for example, to check their wear).

The housing 150 has part of its wall as a guide part 1501. The guide part 1501 guides the paper P conveyed by the paper separation roller 13.

Specifically, the paper separation roller cleaning portion 15 is arranged upstream of the paper separation roller 13 in the paper conveyance direction, below the conveyance path of the paper P. Thus, the bottom face of the paper P conveyed toward the paper feed nip between the paper feed roller 12 and the paper separation roller 13 makes contact with the guide part 1501 so that the paper P conveyed toward the paper feed nip smoothly enters the paper feed nip. As a result, the paper P is conveyed by the paper separation roller 13 satisfactorily. In other words, the guide part 1501 (that is, part of the housing 150) guides the paper P conveyed toward the paper feed nip. In yet other words, the housing 150 has the guide part 1501 that functions as a guide face and keeps the bottom face of the paper P conveyed toward the paper feed nip in contact with the guide part 1501 to guide the paper P conveyed toward the paper feed nip.

In this embodiment, as described above, part of the housing 150 (specifically, the guide part 1501) is arranged at a position where it can make contact with the paper P. Then, the part of the housing 150 guides the paper P conveyed by the paper separation roller 13. This eliminates the need to separately provide, near where the housing 150 is arranged, a member for guiding the paper P and this helps suppress an increase in the size of the paper feeding device 1. It is thus possible to suppress an increase in the size of the paper feeding device 1 while appropriately cleaning the paper separation roller 13.

By appropriately cleaning the paper separation roller 13, the foreign substances such as paper dust deposited on the paper separation roller 13 can be satisfactorily removed. As a result, it is possible to prevent inconvenience such as slippage of the paper separation roller 13 against the paper P. This helps prevent conveyance failure with the paper P.

For example, an area around the paper separation roller 13 is covered with a cover that can be opened and closed to ease sheet jam removal. Opening the cover exposes the area around the paper separation roller 13. With this configuration, opening the cover (that is, the cover for sheet jam removal) around the paper separation roller 13 conveniently permits the mounting and removal of the housing 150.

In this embodiment, the foreign substances deposited on the brush roller 151 are removed by the scraper 152. This prevents insufficient cleaning of the paper separation roller 13 by the brush roller 151. The foreign substances removed from the brush roller 151 are stored in the housing 150 and this prevents the foreign substances from scattering around the paper separation roller 13.

As a modified example, though not shown, a cleaning portion that cleans the paper feed roller 12 may be further provided.

### <Configuration of the Document Conveyance Device>

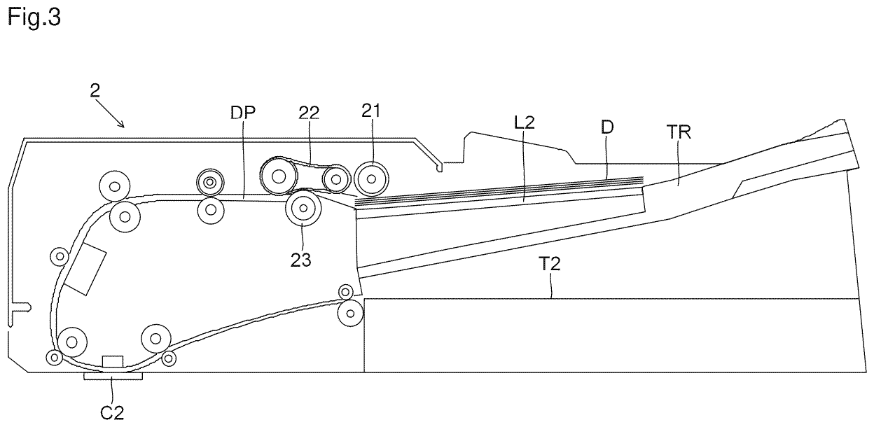

As shown in FIG. 3, the document conveyance device 2 has a document conveyance passage DP. The document conveyance device 2 conveys the document D along the document conveyance passage DP. The document conveyance passage DP passes via a predetermined position on the contact glass C2 that is the reading position in the feed-reading mode. While the document D is being conveyed by the document conveyance device 2, the document D passes across the predetermined position on the contact glass C2. This permits the reading of the document D in the feed-reading mode.

The document conveyance device 2 includes a document tray TR. On the document tray TR, the document D is set. The document conveyance passage DP extends from the document tray TR via the predetermined position on the contact glass C2 to the discharge tray T2. When a job that involves the reading of the document D, such as a copy job, is performed in the feed-reading mode, The document D on the document tray TR is sequentially fed to the document conveyance passage DP and is conveyed along the document conveyance passage DP. Thus, the document D on the document tray TR decreases. The read document D is discharged to the discharge tray T2.

In the document tray TR, a document lifting plate L2 is arranged. Setting the document D on the document tray TR leaves the document D placed on the document lifting plate L2. The document lifting plate L2 can be displaced such that its downstream end in the document conveyance direction swings in the up-down direction about its upstream end in the document conveyance direction. In other words, the document lifting plate L2 is movable up and down. In the following description, the rising of the document lifting plate L2 means the upward movement of the downstream end of the document lifting plate L2 in the document conveyance direction.

The document conveyance device 2 includes a document pickup roller 21. The document pickup roller 21 is supported so as to be rotatable about an axis extending in the width direction. The document pickup roller 21 is coupled to a motor, which is not shown, and rotates by being fed with a driving force from the motor. The document pickup roller 21 is arranged opposite the document lifting plate L2 in the up-down direction. With the document D set on the document tray TR, the document D on the document lifting plate L2 and the document pickup roller 21 faces each other in the up-down direction. The document pickup roller 21 rotates while in contact with the top layer of the document D on the document lifting plate L2 from above. The document pickup roller 21, by rotating while in contact with the document D on the document lifting plate L2, conveys the document D on the document lifting plate L2. Thus, the document D is pulled out of the document tray TR.

During a job that involves the reading of the document D, the document lifting plate L2 rises and stops rising repeatedly. The document lifting plate L2 rises until it makes contact with the document D in the top layer on the document lifting plate L2 and when the contact pressure with the document D in the top layer on the document lifting plate L2 reaches a target value, it stops rising. Thus, even when the document D on the document tray TR decreases, the document D on the document tray TR and the document pickup roller 21 are kept in contact with each other.

The document conveyance device 2 includes a document feeding belt 22. The document feeding belt 22 is arranged downstream of the document pickup roller 21 in the document conveyance direction. The document feeding belt 22 is an endless belt. The document feeding belt 22 is stretched around a plurality of stretching rollers (no reference signs are assigned). The plurality of stretching rollers are supported so as to be rotatable about an axis extending in the width direction.

One stretching roller among the plurality of stretching rollers is a driving roller and rotates by being fed with a driving force from a motor, which is not shown. The document feeding belt 22 is driven (that is, rotates) as the driving roller rotates.

The document conveyance device 2 includes a document separation roller 23. The document separation roller 23 is arranged downstream of the document pickup roller 21 in the document conveyance direction. The document separation roller 23 is supported so as to be rotatable about an axis extending in the width direction.

The document separation roller 23 is in pressed contact with the document feeding belt 22 and forms a document feed nip with the document feeding belt 22. When the document D is pulled out of the document lifting plate L2, the document D enters the document feed nip. The document feeding belt 22 and the document separation roller 23, by rotating while in contact with the document D having entered the document feed nip, conveys the document D having entered the document feed nip.

The document separation roller 23 is coupled to a torque limiter (not shown). The torque limiter is arranged on the rotation shaft of the document separation roller 23. The torque limiter keeps the rotation shaft of the document separation roller 23 unrotatable if the rotational driving force transmitted from the document feeding belt 22 to the document separation roller 23 is equal to or lower than a threshold value. When one and the subsequent sheets of document D overlapping with each other enter the document feed nip, the document feeding belt 22 makes contact with the first document D and advances it, but the document separation roller 23 does not make contact with the first document D and makes contact with the second document D. This makes it difficult for the rotational driving force to be transmitted from the document feeding belt 22 to the document separation roller 23. Thus, the rotational driving force transmitted from the document feeding belt 22 to the document separation roller 23 becomes equal to or lower than the threshold value and the document separation roller 23 does not rotate.

In this way, while the document feeding belt 22 rotates, the document separation roller 23 does not; this prevents the advancement of the second document D that is out of contact with the document feeding belt 22 but in contact with the document separation roller 23. Thus, one and the subsequent sheets of document D are separated. This eliminates double feeding, that is, feeding of a plurality of sheets of document D overlapping with each other.

The document conveyance device 2 includes one or more pairs of document conveyance rollers, which are not shown. The pair of document conveyance rollers have a pair of rollers kept in pressed contact with each other. The pair of document conveyance rollers have a region between the pair of rollers as a document conveyance nip. The pair of document conveyance rollers rotate to convey the document D having entered the document conveyance nip. In other words, the pair of document conveyance rollers nip the document D between the pair of rollers and rotates in that state to convey the document D. The pairs of document conveyance rollers are arranged in the document conveyance passage DP and convey the document D along the document conveyance passage DP.

### <Configuration of the Document Feeding Belt Cleaning Portion>

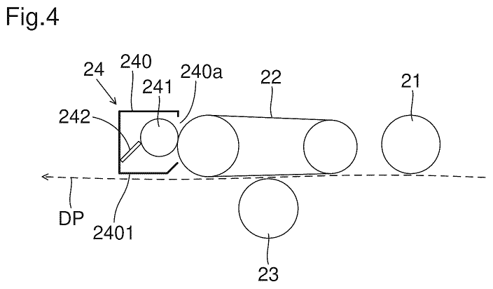

The document feeding device 2 includes a document feeding belt cleaning portion 24 (see FIG. 4). The document feeding belt cleaning portion 24 cleans the document feeding belt 22. In this configuration, the document feeding belt cleaning portion 24 corresponds to a “cleaning portion” and the document feeding belt 22 corresponds to a “rotating member”.

The document feeding belt cleaning portion 24 removes foreign substances from the outer circumferential surface of the document feeding belt 22. On the outer circumferential surface of the document feeding belt 22, paper dust deposits as a result of the document D making contact with it. In the cleaning of the document feeding belt 22 by the document feeding belt cleaning portion 24, at least paper dust is removed as foreign substances from the outer circumferential surface of the document feeding belt 22.

The document feeding belt cleaning portion 24 includes a housing 240, a brush roller 241, and a scraper 242. The brush roller 241 corresponds to a “cleaning member”.

The housing 240 has a storage area. Specifically, the housing 240 is in the shape of a box and has a wall surrounding a space that serves as the storage area. A box-shaped member as the housing 240 has an opening 240a through which the internal area (that is, the storage area) of the housing 240 communicates with an external area. The housing 240 stores the foreign substances removed from the document feeding belt 22 in the storage area.

The housing 240 is removably mountable in the main body of the document conveyance device 2. With the housing 240 removed from the main body of the document conveyance device 2, the foreign substances stored in the housing 240 can be disposed of. After disposal, the housing 240 is mounted back in the main body of the document conveyance device 2.

The brush roller 241 is rotatably attached to the housing 240. The brush roller 241 has a rotation shaft and a plurality of bristles raised from the outer circumferential surface of the rotation shaft. The brush roller 241 keeps the bristles in contact with the outer circumferential surface of the document feeding belt 22.

The scraper 242 is attached to the housing 240. The scraper 242 lies in contact with the outer circumferential surface of the brush roller 241. The brush roller 241 rotates with its outer circumferential surface in contact with the scraper 242. The scraper 242 makes contact with the outer circumferential surface of the brush roller 241 to electrostatically charge the brush roller 241. The brush roller 241 electrically attracts foreign substances that deposits on the outer circumferential surface of the document feeding belt 22 to remove the foreign substances from the outer circumferential surface of the document feeding belt 22. The scraper 242 makes contact with the brush roller 241 to remove the foreign substances from the outer circumferential surface of the brush roller 241. The foreign substances removed from the outer circumferential surface of the brush roller 241 drop to be stored in the storage area in the housing 240.

The brush roller 241 is arranged in the storage area in the housing 240, with part of it exposed outside the storage area through the opening 240a in the housing 240. The brush roller 241 keeps the part of it exposed through the opening 240a in the housing 240 in contact with the document feeding belt 22.

The scraper 242 is arranged in its entirety in the storage area in the housing 240. One end of the scraper 242 lies in contact with the outer circumferential surface of the brush roller 241 and the other end of it is attached to the housing 240. Thus, the foreign substances removed from the outer circumferential surface of the brush roller 241 by the scraper 242 are stored in the storage area in the housing 240.

With the configuration where the brush roller 241 and the scraper 242 are attached to the housing 240, the brush roller 241 and the scraper 242 can be removed from the main body of the document conveyance device 2 simply by removing the housing 240 from the main body of the document conveyance device 2. Conveniently, it is thus possible, on the occasion of disposing of the stored substances (foreign substances) stored in the housing 240, also to maintain the brush roller 241 and the scraper 242 (for example, to check their wear).

The housing 240 has part of its wall as a guide part 2401. The guide part 2401 guides the document D conveyed by the document feeding belt 22.

Specifically, the document feeding belt cleaning portion 24 is arranged downstream of the document feeding belt 22 in the document conveyance direction, above the conveyance path of the document D. Thus, the top face of the document D having passed through the document feed nip between the document feeding belt 22 and the document separation roller 23 makes contact with the guide part 2401 so that the document D having passed through the document feed nip is smoothly conveyed. As a result, the document D is conveyed by the document feeding belt 22 satisfactorily. In other words, the guide part 2401 (that is, part of the housing 240) guides the document D having passed through the document feed nip. In yet other words, the housing 240 has the guide part 2401 that functions as a guide face and keeps the top face of the document D having passed through the document feed nip in contact with the guide part 2401 to guide the document D having passed through the document feed nip.

In this embodiment, as described above, part of the housing 240 (specifically, the guide part 2401) is arranged at a position where it can make contact with the document D. Then, the part of the housing 240 guides the document D conveyed by the document feeding belt 22. This eliminates the need to separately provide, near where the housing 240 is arranged, a member for guiding the document D and this helps suppress an increase in the size of the document conveyance device 2. It is thus possible to suppress an increase in the size of the document conveyance device 2 while appropriately cleaning the document feeding belt 22.

By appropriately cleaning the document feeding belt 22, the foreign substances such as paper dust deposited on the document feeding belt 22 can be satisfactorily removed. As a result, it is possible to prevent inconvenience such as slippage of the document feeding belt 22 against the document D. This helps prevent conveyance failure with the document D.

For example, an area around the document feeding belt 22 is covered with a cover that can be opened and closed to ease sheet jam removal. Opening the cover exposes the area around the document feeding belt 22. With this configuration, opening the cover (that is, the cover for sheet jam removal) around the document feeding belt 22 conveniently permits the mounting and removal of the housing 240.

In this embodiment, the foreign substances deposited on the brush roller 241 are removed by the scraper 242. This prevents insufficient cleaning of the document feeding belt 22 by the brush roller 241. The foreign substances removed from the brush roller 241 are stored in the housing 240 and this prevents the foreign substances from scattering around the document feeding belt 22.

As a modified example, though not shown, a cleaning portion that cleans the document pickup roller 21 may be further provided, or a cleaning portion that cleans the document separation roller 23 may be further provided.

It should be understood that the above-described embodiments are in every aspect illustrative and not restrictive. The technical scope of the present disclosure is defined not by the description of the embodiments given above but by the appended claims, and encompasses any modifications made without departure from the scope and sense equivalent to those claims.

What is claimed is:

1. A sheet conveyance device comprising:
a rotating member that rotates while in contact with a sheet, the rotating member conveying the sheet; and
a cleaning portion that cleans the rotating member,
wherein
the cleaning portion has:
a cleaning member that makes contact with an outer circumferential surface of the rotating member to remove foreign substances from the outer circumferential surface of the rotating member; and
a housing that stores the foreign substances removed from the outer circumferential surface of the rotating member, and
a part of the housing is arranged at a position where the part can make contact with the sheet, the part guiding the sheet conveyed by the rotating member.

2. The sheet conveyance device according to claim 1, wherein
the cleaning portion further includes a scraper that makes contact with an outer circumferential surface of the cleaning member to remove foreign substances from the outer circumferential surface of the cleaning member, and
the housing stores the foreign substances removed from the outer circumferential surface of the cleaning member by the scraper.

3. The sheet conveyance device according to claim 2, wherein
the cleaning member and the scraper are attached to the housing, and
the housing is removably mountable in a main body of the sheet conveyance device.

4. The sheet conveyance device according to claim 1, wherein
the cleaning member is a brush roller that rotates while in contact with the outer circumferential surface of the rotating member.

5. An image forming apparatus comprising:
the sheet conveyance device according to claim 1; and
a print portion that prints on the sheet being conveyed by the sheet conveyance device.

6. An image reading apparatus comprising:
the sheet conveyance device according to claim 1; and
an image reading portion that reads an image formed on the sheet being conveyed by the sheet conveyance device.
